(19) United States
(12) Patent Application Publication
(10) Pub. No.: US 2004/0075681 A1
(43) Pub. Date: Apr. 22, 2004

(54) Web-based feedback engine and operating method

(76) Inventor: Daniel Anati, Ramat-Gan (IL)

Correspondence Address: Edward Langer, Landon & Stark Associates, One Crystal Park, Suite 210, 2011 Crystal Drive, Arlington, VA, 22202, US

(21) Appl. No.: 10/416,737

(22) PCT Filed: Nov. 14, 2001
(86) PCT No.: PCT/IL01/01054

(51) Int. Cl. G09G 5/00

(52) U.S. Cl. 345/738

(57) ABSTRACT

A dynamic, web-based, feedback polling system providing actual feedback questions (20) which a surfer (10) on the web (14) is prompted to answer on-line using a minimal number of clicks and providing feedback editors and writers with only a minimum number of fields to utilize. The feedback questions (20) are loaded to any web page linked to a feedback engine (18), which comprises a database server for storing feedback objects and dynamically-generating all display protocol code and for displaying, maintaining, monitoring, recording information flow and data, and making all calculations needed for maintaining a feedback collecting interface connectable to any web page. The invention further provides for an efficient feedback operating method, as well as a feedback set-up and editing method which requires only minimal user input of feedback parameters in a minimal number of fields displayed in a GUI.

### FIELD OF THE INVENTION

The present invention relates to on-line data processing systems on the Web, and in particular, to a Web-based Feedback engine and polling system, and operating method for providing feedback services configuration, collection, and processing.

### BACKGROUND OF THE INVENTION

Current Web-based query feedback systems are problematic from at least five standpoints: First, the vast majority of quality feedback systems currently in use are generated by tedious and time-consuming programming of code. Second, current feedback systems on the Internet require surfers to make two or more clicks in order to participate in the feedback process. However, every surfer click is a deterrent to participation and the goal of those making queries for feedback is to search for the minimal required number of clicks for feedback participation. Third, input data must be received, analyzed, computed and stored by a server and not all servers (especially virtual ones) enable this computing. Even if they do, the cost can be high. Programming manpower is expensive: in an ordinary system, human programming manpower is used to codify the feedback requests inputs and outputs, as defined by feedback copywriters. Fourth, hard coded forms suffer from the disadvantage of being fixed and therefore inefficient in the use of display resources. Fifth, feedback copywriters usually rely on other human programmers in order to insert their feedback requests. This step requires time consuming coordination, expensive human programing manpower and resources.

### SUMMARY OF THE INVENTION

Accordingly, it is a principal object of the present invention to overcome the disadvantages of prior art Web-based feedback systems, and provide a feedback method in which no programming is needed since, in a preferred embodiment of the present invention, the feedback object is dynamically generated by DHTML code loaded and calling an external JavaScript file residing on the server comprising the Feedback engine. Therefore the only operation required is to insert the following fixed JavaScript call in any web page:

<script language=“JavaScript1.2”src=“http://www.f-polls.com/load.js“></script>

Furthermore, the Feedback engine may link to a new window in which a feedback search engine of the present invention will show not pages referenced, but actual questions which the surfer is enabled to answer. This innovative approach improves several aspects of efficiency:

The search engine is activated from within any presented question, or manually by the surfer entering the appropriate URL in his browser. In both cases the surfer performs an active operation and therefore the surfer is prone to be presented with more questions.

The surfer entered some keywords, and is therefore interested in specific questions. Several questions are presented at once in a proprietary page, virtually created by the feedback search engine. The surfer can answer one or more questions according to the surfer's preferences.

The feedback question page also includes links to pages by categorized questions, i.e., containing questions generated by specific sector Site managers. A Site manager can include any question in these pages (using the option to display a question anywhere), therefore enlarging the convenient provision of answers from other pages in the Web and especially from the Feedback engine surveys.

A Site manager can decide not to reveal the origin of the question, i.e., the Site manager's identity. This approach is sometime preferred just for anonymity, but can also influence participation and sometime reveal future intentions of the site owner.

For example, several questions by Motorola or Intel are likely to attract more attention not only from participants, but also from the competition. Not revealing the source is a very effective way for global firms to conduct surveys on future products without revealing their intentions and without losing their marketing advantage.

In particular, the feedback processing system comprises: computer resources, such as: Feedback engine databases for questions, answers, sites, and users (authorization); log files; remote computer links (e.g., Internet); display protocol (e.g., HTML); and input protocol (e.g., HTML forms).

By including all feedback related information in a database, the Feedback engine is capable of several activities previously not available, such as providing a setup tool that is user-friendly; a system which enables the easy, quick, and efficient use, update, and review of feedback queries; and the inclusion of convenient analysis tools. This approach enables production of a virtual basket of questions for each page connected to the Feedback engine. The Feedback engine software enables a Feedback copywriter to virtually determine the questions basket for a page as a function of several parameters introduced either in the question definition (as language, priority, seek counter, display period) or in the page definitions or even a particular surfer's parameters (such as country of origin vs. language). Such functionality is only available due to the dynamic Feedback engine concept of the present invention.

Questions are stored in a database and all display code (as HTML or other) is dynamically generated, enabling support for current and future web protocols. Questions are edited through a password-protected interface with the database, enabling only authorized persons to set up questions. Clicking a link generated by the dynamic engine inside the feedback object opens a new window with the Feedback engine setup interface. In accordance with a preferred embodiment of the present invention, the question text serves as such a link, and the e-mail address for each coordinator is the username, thus minimizing the parameters to be remembered to only the coordinator's password. Each question can be edited through one form, enabling easy and direct change of question formulations as well as the type of method for displaying answers and delimiting the possible answers.

Any site's Feedback copywriter can setup questions in or above any web page once the Site manager (the person who has the writing access to that page) has included the code call to the Feedback engine. Sequential loads of that page will include a feedback request object including a header, a question, and relevant enabled answers. Links to the editing system and to a feedback tutorial are provided in the screen display. Questions can be shared among different pages from the same web site, or even from different sites.

One object of the present invention is to enable a Feedback copywriter to insert and edit the feedback requests and possible answers and related parameters and data easily, quickly and efficiently, without the need for any knowledge of the communication protocol language (such as HTML), rather just by typing the question and possible answers with a minimal number of clicks and with a minimal number of fields to fill, viz.:

1 Question: Just type-in the question in the question field.

2 Answers: Just type-in a comma-separated list of the available answers, or the default answer string, according to the question type, in the answers field.

A further object of the present invention is to provide a data processing system for displaying, monitoring, and recording information flow and data, including mailing all calculations necessary for maintaining a web-based feedback database. This database enables dynamic question selection at load time and provides the possibility to automatically present the more relevant question from a group of existing questions (page basket) by altering the following question parameters:

3 seek counter (display only a question for which a certain number of answers have not yet been reached);

4 display period (e.g., display only the question whose current date is between a starting date and an ending date, or a starting date and a period defined in days, weeks or months. Note that time relevancy is critical, because if the answer to a question is not timely and has implicit relevance mainly to the past, it very likely will be ignored as unworthy of response.);

5 priority (e.g., give greater chances to a question with a higher priority while randomly choosing among them);

6 language (e.g., display in a given page only questions in that same language, or enable display in a given page of questions in the surfers' language);

7 automatic refresh after answering (or a time-out period—e.g., 35 seconds—this attracts more attention than a static display, and uses the same display resources to display more questions).

This method requires only one click per answer instead of the generally implemented two clicks used: one to choose an answer and one to press a ‘vote’ or ‘submit’ button. Furthermore, a surfer does not have to take any positive action, such as click a link or a button, to see the feedback requests, as they are, in one embodiment of the invention, generated dynamically by the Feedback engine as part of the page the surfer is already visiting. Alternatively, they can be generated so as to appear as levitating on the page.

If the surfer does not participate, a new question will be presented after a time-out period (e.g., 35 seconds). Such change is efficient both to call the surfer's attention and also to better and more efficiently use display resources, i.e., use the same display area to present more feedback requests over a period of time.

Levitating feedback requests: using DHTML techniques, the Feedback engine will create the feedback requests as separated objects moving above the connected page. This approach enables the inclusion of a question without changing the look of the page (the inclusion of any display code in the page itself can compromise its balance and require costly programming resources. Otherwise, as the in the preferred embodiment of the invention, the question may appear in a fixed position as any other object presented. In such case, the code call position inside the HTML code fixes the feedback object position in the HTML page. The levitating object approach also enables calling the surfer's attention without bothering him too much, adjusting the moving object entrance timing and direction, speed, acceleration and pauses while on the viewing window. The sequence may be such that after a brief pause to enable participation (i.e., 10 seconds), the feedback request moves out of the viewing screen to return again with a new question after another pause (i.e., another 35 seconds).

Thus the feedback collecting method of the invention requires the minimal number of clicks per answer (in most cases any participating surfer will just need one click to express his opinion). This method is most efficient because it does not require the surfer to click a button just to enter in the feedback question area or page, but the feedback request is presented together with the visited page, therefore directly exposing the question to the surfers' eyes, and the feedback object is utilized again both in case of participation and in case of non-participation, recalling the surfers' attention to the question request.

The feedback setup method is also the minimal required for the Site manager and the Feedback copywriter, because once the Feedback engine call is included inside a web page source code (the insertion of one line of code, once, is the minimal task required), all the activities needed to maintain the feedback collecting activity are reduced to the minimal number of clicks required to edit the code's syntax

Thus there is provided in a preferred embodiment of the invention, a dynamic, Web-based, feedback polling system comprising:

a virtual Feedback engine comprising a normalized database for storing and processing at least one feedback object selected from a plurality of feedback objects, said at least one feedback object comprising at least one feedback question and at least one associated default answer, said engine being in communication over the Internet with at least one surfer, and being activated by a fixed, single line of embedded code contained in at least one Web page for controlling the display of said feedback object in said at least one Web page downloaded by said at least one surfer;

at least one database in communication with said engine for storing at a minimum, a plurality of feedback questions, associated default answers, feedback site addresses and information on users of said system;

a graphic user interface (GUI) for operating said system and for enabling setup and editing of said stored feedback questions and said associated default answers,

said system providing access to said at least one feedback object by a surfer for responding to said at least one feedback question using a minimal number of clicks, and providing access to said Feedback engine by authorized users, said authorized users performing, via said GUI, setup and editing operations of parameters associated with said feedback object displayed to said at least one surfer,

said system also providing at least one summary report and analysis of a plurality of said surfer responses.

There is further provided, in another aspect of the invention, a feedback operating method comprising:

loading at least one feedback object for display to a surfer in a GUI;

positioning said object in at least one of a fixed position for said object and a levitating state above a Web page called by said surfer;

pausing for a specified time period to await a response from said surfer;

reloading a different feedback object after expiration of said specified time period for said response from said surfer;

transmitting gathered responses; and

reloading at least one new feedback object for display to said surfer on said GUI.

The Site manager benefits from the fact that the feedback collecting process is automatically directed to present only relevant questions in terms of the current date timeframe, and relevant questions for which an insufficient number of answers for a meaningful trend (i.e., 30) might not yet have been collected. The Site manager also gains from the fact that he/she can continue to characterize his/her feedback, collect and edit questions, enter new or future questions, access answers, and perform results analysis just by the minimal number of clicks.

The Site manager also gains from the fact that all that is needed to remember is just a password, and the Site manager is required to use his/her e-mail address as a username. The system requires using the e-mail address as the username.

The Site manager also gains from the fact that no human manpower is needed to code the feedback requests, and no human manpower is needed to analyze results or to update the system, because all the relevant data can be entered by the Feedback copywriter who also need not have any programming knowledge. Of course it is assumed that the Feedback copywriter has enough knowledge to operate the Feedback engine front-end setup, a knowledge that is expected from one skilled in the art of setting up a computerized feedback system The Site manager further benefits from the fact that he/she can keep his/her web pages on the same server currently being utilized, or change anytime to another server (also virtual ones), without worrying about that server's dynamic capabilities, since all the computation concerning feedback data collecting, setup and analysis is done via the Feedback engine server. This may also considerably reduce the fees required to keep his/her pages on a (virtual) server.

Additionally, the Site manager gains from the fact that proprietary feedback data is kept locally in the Site manager's database, and therefore the actual question presentation and answers data is dynamically created by the Feedback engine at loading time. This process can therefore be executed generating different display and/or form codes, enabling future implementation of the manager's data in any other protocol that is not HTML, but which has similar capabilities.

In another embodiment of the invention, the system enables the creation of dynamic Web surveys. A Web survey is composed of one or more ordered list of questions (survey pages). Each survey page is dynamically generated according to the list and other parameters, as described above, at loading time. The answers from the previous survey page can determine which questions will be included in the next page, enabling survey presentation according to the participant's response.

Other features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 depicts a preferred embodiment of the system architecture of the present invention;

FIGS. 2A and 2B, respectively, illustrate a sample of a feedback poll and the Feedback engine-generated summary report for the sample query, including responses to the query collected in accordance with a method provided in a preferred embodiment of the present invention;

FIG. 3 depicts an example of a GUI of a Feedback engine display screen for feedback setup and editing, showing the various options available to a Feedback copywriter/editor to set up and edit feedback questions and answers in accordance with a preferred embodiment of the invention;

FIGS. 4A to 4F shows examples of various types of feedback as seen on-screen in graphic user interfaces (GUIs);

FIG. 5 shows a flowchart of the general workflow of the Feedback engine in accordance with a preferred embodiment of the present invention,

FIG. 6 shows a flowchart of the workflow for loading and updating feedback questions/answers by the Feedback engine; and

FIG. 7 shows a flowchart for the process of set up and editing in accordance with a preferred embodiment of the present invention.

### DETAILED DESCRIPTION OF THE PREFERRED EMBODIMENTS

The invention will now be described in connection with certain preferred embodiments with reference to the following illustrative figures so that it may be more fully understood. References to like numbers indicate like components in all of the figures.

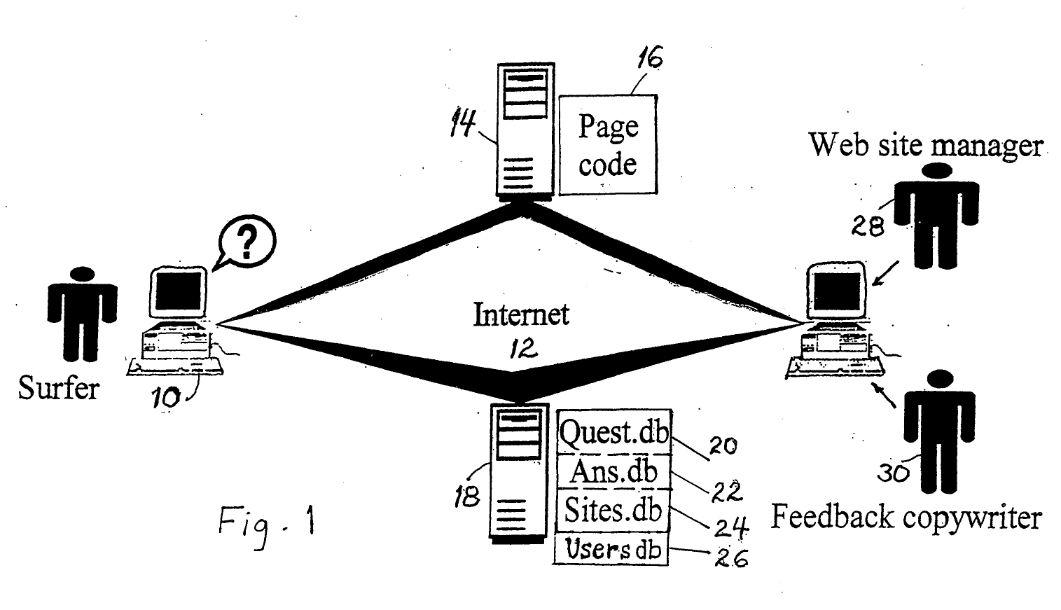

Referring now to FIG. 1, there is depicted a preferred embodiment of the system architecture of the present invention.

The system is primarily designed for the following users as depicted in FIG. 1:

A Surfer 10: a person with Internet access calls a Web page over the Internet 12. A first Website server 14 provides Surfer 10 with the requested Internet service by loading Page code 16 to display the requested page. A second server 18, hereinafter referred to as a Feedback engine, stores data in various databases, such as, by way of example, in blocks 20 through 26, in accordance with a preferred embodiment of the invention. Databases are provided for feedback Questions 20, Answers 22, registered Sites 24, and Users 26, who are authorized to use Feedback engine 18. Loading the site Page code 16, the browser reacts to the included code, emitting a request to Feedback engine 18 to load a question from Question database 20 which will be provided for display to the site page seen by Surfer 10.

Web Site manager 28: a person who is responsible for maintaining the Web site pages code and sometimes referred to as a Webmaster. (Hereinafter Web Site manager 28 will be referred to as Site manager). Any site has at least one person who retains the password to gain write-access to the site files. In order to enable Feedback engine 18 in a certain Web page, Site manager 28 is required to initially change the code for the specified page, including a call to load Feedback engine 18.

Feedback copywriter 30: (also referred to as a Website copywriter) a person who formulates the feedback requests. This person does not need to know HTML or other display code programming or even how to use an editor. This person usually knows very well the present and future organization projects and is therefore the best-suited person to formulate meaningful questions to present to passing visitors surfing in the organization Web site. Many sites on the Internet are created and maintained by one person. In such a case, the same person functions as Site manager and Feedback copywriter for these various Web sites.

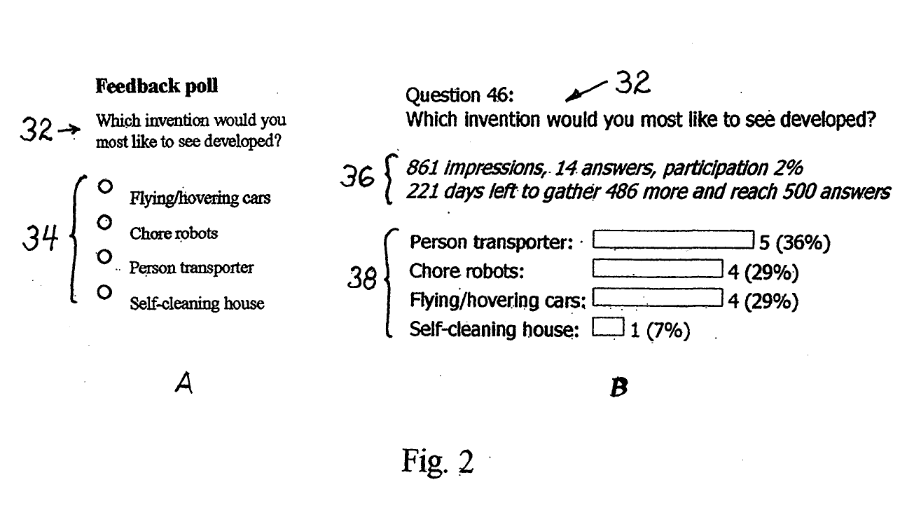

FIGS. 2A and 2B, respectively, illustrate a sample of a feedback poll and a Feedback engine-generated summary report for the sample query, including responses to the query collected in accordance with a method provided in a preferred embodiment of the present invention.

FIG. 2A shows a GUI of a typical, on-line feedback query and the format type provided from a feedback pool (basket) maintained by the Feedback engine. Query 32 is displayed together with appropriate feedback answers 34 in an example of one type of display, in this case, a radio type enabling a user, typically a surfer, to respond with one click next to the user's choice of response among the default answers supplied by the Feedback engine. In contrast to existing applications, it should be noted that this feature of the present invention reduces the required clicks to the absolute minimum of a single click in order for a surfer to participate. There is no need to press any additional button, such as “vote” or “submit”. The Feedback engine does this automatically and transparently to the user.

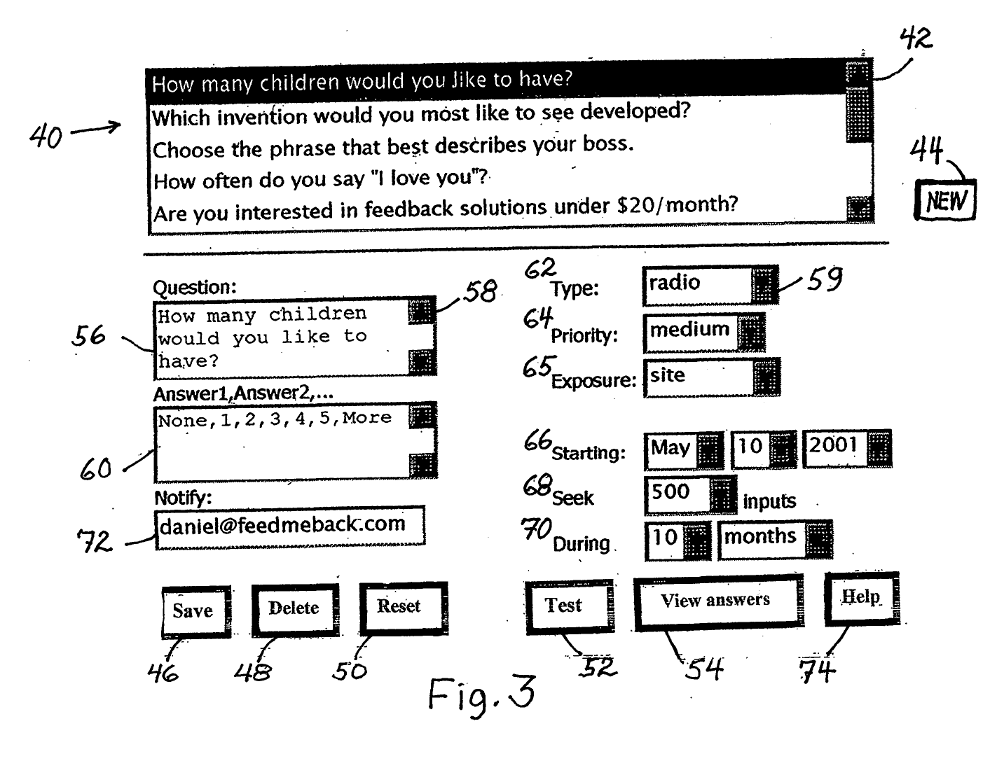

FIG. 2B illustrates a sample Feedback engine report for query responses gathered in accordance with a preferred embodiment of the present invention. The reported question 32, “Question 46”, is shown by way of example only. The report also shows a summary 36 of the results gathered, and a prioritized list of answers 38 for the given question, including a graphic and statistical analysis (by number of responses and percent of total). A report, such as shown in FIG. 2B, is available to an authorized Site manager and/or Feedback copywriter, in accordance with the principles of the invention. It is automatically generated by the Feedback engine and can be viewed from the Feedback engine setup and editing interface (See FIG. 3).

FIG. 3 depicts an example of a GUI of a Feedback engine display screen for feedback setup and editing, showing the various options available to a Feedback copywriter/editor to set up and edit feedback questions and answers in accordance with a preferred embodiment of the invention.

One portion of the GUI display screen, such as the upper part in the example, provides for navigation through the questions stored in the Feedback engine database. In the example shown here, a question (highlighted) is currently displayed in Field 40 from a virtual basket of questions. Clicking the right down arrow 42 displays a scrollable list of these other questions for selection. A Feedback copywriter can choose a question to focus on and access all his/her question parameters through this navigation control.

In summary, with one click of button 42, a Feedback copywriter can open a list of questions, for every page registered by the Feedback copywriter. Clicking any of the question lines in Field 40 will reload the feedback question setup editor to that specific feedback question. The Feedback copywriter can scroll the list of all available questions. This process ensures an optimal click distance from editing the contents of any proprietary feedback question. A Feedback copywriter enters all feedback answer choices in one field, in a command-separated list. No scrolling is required since all editing parameters appear together on one feedback-editing screen. This is a major breakthrough in the human interface generally used with existing Systems for providing feedback. The present invention not only saves valuable time, but also is more efficient than other, existing systems. There is no need to go from page to page to see all the editing parameters and Feedback copywriters do not need to write any HTML code in order to create dynamic feedback windows.

By clicking button, New 44, a Feedback copywriter is enabled to create a new feedback question using the parameter fields displayed in the lower portion of the setup screen as shown in FIG. 3. To insert a new question in the Feedback engine, the Feedback copywriter clicks button Save 46. Clicking button Delete 48 will remove the question from the Feedback engine altogether. A Feedback copywriter is prompted for confirmation prior to final deletion as assurance that this is what is intended. Pressing button Reset 50 will drop any changes entered since the last Save 46 or Delete 48 operation.

Clicking button View answers 54 opens a new window and shows the pertinent feedback report by accessing collected feedback answers for analysis (as shown in FIG. 2B which depicts a sample Answers Analysis Report). In another embodiment, the collected feedback summary report appears directly on the same page as the setup and editing interface.

In addition, a Feedback copywriter has the option to easily and conveniently access and view feedback question-editing results at Test block 52. The Feedback copywriter is provided with a visual simulation of the look and feel of a given question and feedback type as presented on-screen to a surfer. This is a preferred method to enable the Feedback copywriter to judge, usually on the fly, the question and feedback combination and to immediately make changes and improvements, if necessary, in a most efficient manner.

The question under focus by a Feedback copywriter is entered in Field 56 in concise text and must also include end punctuation Field 56 is provided with a display allowing for display of up to three lines of text at a time. Short questions are preferred, but text of more than three lines can be simply viewed by scrolling. Default answer(s) are entered into Field 60 in a comma-delimited series.

Scroll bar 58, such as by Question Field 56,or a down arrow 59, as by Type Field 62, are advantageously provided next to parameters where other options can be displayed by clicking to access a list in a larger window, for easier viewing, or for scrolling for options.

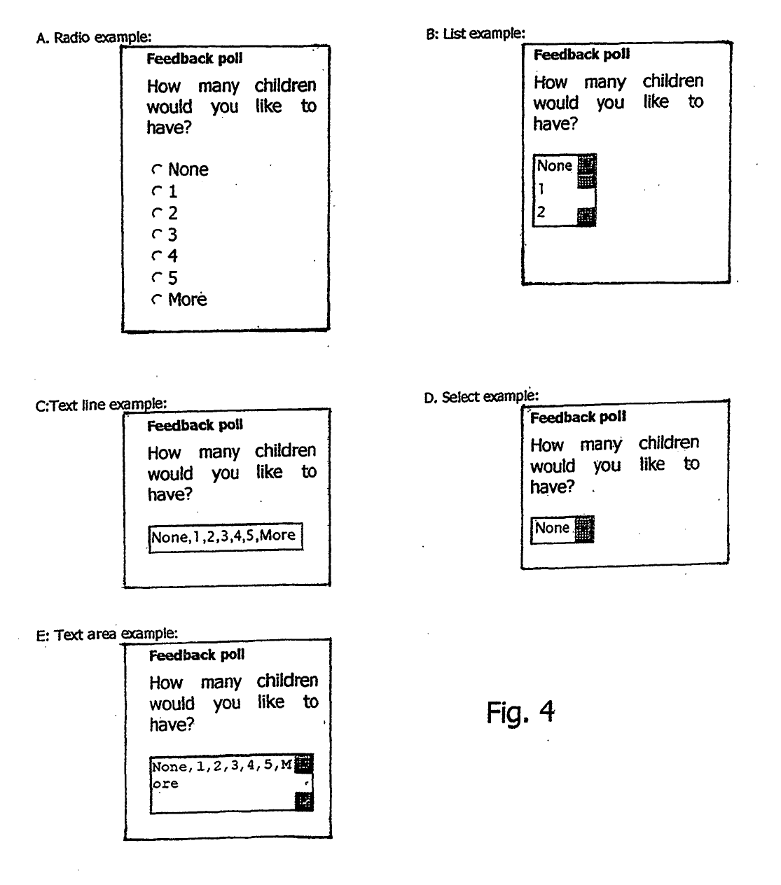

Answers may be provided in a number of types as shown in Type Field 62 where, by way of example, the type is Radio. (See FIG. 4 for illustrations of examples.) The comma character is a delimiter for multiple options in the Radio, List and Select answer types (see FIGS. 4A, 4B, and 4D, respectively). Choosing the Radio, List or Select options will generate optional answers as delimited by the comma character in the answer's parameter. Text line answer type (see FIG. 4C) and Text area type (see FIG. 4E) will use the answer parameter as the default text Choosing Checkbox type (see FIG. 4F), the answer parameter will be displayed to the right of a checkbox which will appear along with the question.

The feedback processing method, in a preferred embodiment of the invention, enables Feedback copywriters to self-insert the questions and default answers, utilizing a minimal click process.

A surfer will also be able to answer with the minimal number of clicks. If the answer is open, i.e., it is a Text line or Text area type, the surfer will only need to input his/her answer and press Enter. If the surfer has to choose among a list of possibilities, i.e., Radio, List, Select, and Checkbox, choosing one answer will transmit the answer data back to the Feedback engine which will then load a new question.

Questions will be displayed on a registered surfer's pages randomly picked from available ones. A Priority Field 64 allows for increasing the chances of the current question in reference to questions with lower priority by applying priority control. Of course, if all questions are given the same high priority, the Feedback engine will not respond to such a parameter as it will be meaningless. Priority is defined as Low, Medium, High, Urgent, and Top. (The visible portion of Priority Field 64 shows setting at “Medium” priority.)

An Exposure Field 65 enables the presentation of the relevant feedback question at several levels of a URL: the feedback question homepage only, in any page of the same site, in any page of the group (i.e., any page owned by the same manager, or any page manually defined as part of the group both by the question owner as by the other page owner), and anywhere, i.e., in any page that enables the display of feedback questions from other origins.

The Starting Field 66 allows a Feedback copywriter to enter a specific date (month, day, and year) which can be called up for display from a drop-down list simply by using the right downward arrows. The question will be presented to surfers beginning on the date specified. The default for a new question is the creation date at the Feedback engine server, presently located in the USA., since this is the backbone for major portions of the Web, especially the Internet. Any question can be programmed as the continuation of a prior question, setting its starting date to the date following the date limit of the prior question, or to a suitable later date selected by the Feedback copywriter.

The Seek Field 68 specifies the number of answers, such as 500 in the example shown, which a Feedback copywriter is interested in collecting. This makes very efficient use of computer resources since the Feedback engine will stop presenting the question to surfers once the number of inputs specified is reached. Effectiveness is also enhanced by limiting the use of display resources for a question when there are already enough answers collected, since displaying another question, instead of the same one, can yield better feedback results. The number of inputs for effective feedback results ranges from 30 to 1000 in accordance with a preferred embodiment of the invention.

The During Field 70 allows a user to specify a time limit up to ten months (for example), beginning with the Starting date (from Field 66). The Feedback engine will stop to present the question also if Seek Field 68 goal for inputs is not reached. To give more weight to the Seek Field 68 goal, the user may specify a longer period (up to ten months) in During Field 70.

The Notify Field 72 provides an option to send notifications to an e-mail address about relevant inputs concerning the specific feedback question. This feature enables a Feedback copywriter to coordinate feedback collecting for different entities.

Clicking button Help 74 will open a new window describing the use of the feedback GUI help features. These features are described by way of example and suggestion only and are not to be construed as an exhaustive list of possible parameters and options for operating the system of the present invention.

In a preferred embodiment of the invention, these Help features comprise:

Question phrasing: The question is just typed in the relevant field area with minimal clicks.

Possible (default) answers list: The example shown in Answer Field 60, represents, in accordance with the question type, the default answer for open answers, or a one character-delimited list of answers, for example, a comma-delimited list of enabled answers. This is the shortest, and most efficient, possible way to describe answers (where each answer comprises phrasing and a one character-delimiter between each item).

Possible type of answer (as available in the input protocol). Available types in the HTML forms protocol are: Radio, Select, List, Checkbox, Text line, and Text area (see FIG. 4 for examples).

Priority setup Priority Field 64): Question priority relative to other questions: e.g., Low, Medium, High, Urgent, Top. The actual weight of each level can vary, keeping the levels in order. One implementation can be multiplying by two the weight of the next level, e.g., Low=1, Medium=2, High<4, Urgent=8, Top=16. This means that while randomly choosing between a Low priority question and an Urgent question, if the Low priority has a 1/9 chance, the Urgent question will have an 8/9 chance.

Language: This option (not shown) enables specifying the language for the question and answers (e.g., English, French, Italian, German, and Hebrew) in order to ensure that a certain page will not present a question in an undesired language (to present a question in German on an English page will call attention to itself, but not result in any relevant answers. The only exception is, for example, if the specific surfer is German-speaking and therefore prefers to be posed a question in the surfer's native language).

Exposure: This option (Field 65) enables the presentation of the relevant question at several levels of the URL: the question home page only, in any page of the same site, in any page of the group (i.e., any page owned by the same registered user, or any page manually defined as part of the group both by the question owner and by, for example, a host other than the page owner), and anywhere, i.e., in any page that enables the display of questions from another source.

Period: this defines the relevant time frame in which the question is relevant and should be displayed. Such definition can be by means of starting and ending date or a date and a period, i.e., a month, day, and year (as in Staring Field 66) and a number of days/weeks/months (as in During Field 70).

Counter (Seek Field 68): The seek counter controls the number of answers that a Feedback copywriter wishes to collect Dynamic presentation will stop if this goal is reached prior to the end of the specified period. To give more weight to the period, the Feedback copywriter enters a high seek goal. If the number of answers is more important, a longer collecting period is specified.

Subject: specify the question subject (field not shown) for future searches and analysis.

Notification of address (Notify Field 72): The e-mail address for notification to the person in charge of collecting feedback question responses and data.

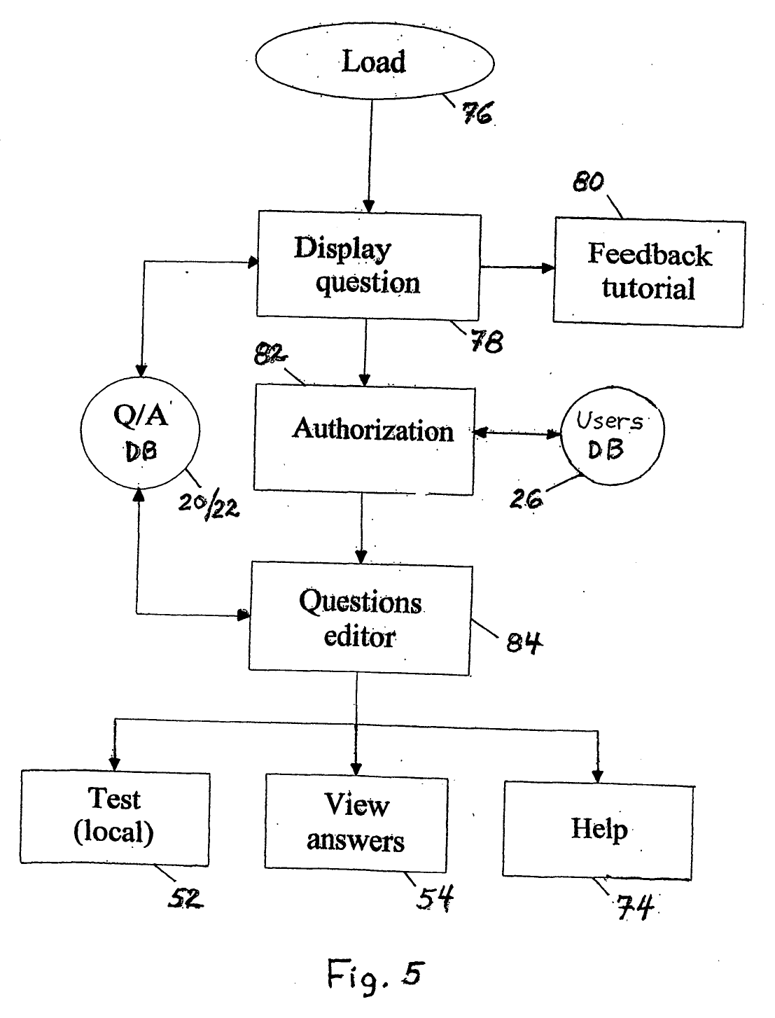

It should be noted that the parameters and options presented above are also applicable in connection with the general flowchart of the method of the invention described below in connection with FIG. 5.

FIGS. 4A to 4E show examples of various types of feedback answers as seen on-line in graphic user interfaces (GUIs). For purposes of comparison, the types are shown with the same sample question and the answers displayed in accordance with the particular type format for answers. The formats are necessarily constrained by the form code used by the server supplying the data over the Web.

The types included in FIG. 4 are not exhaustive, but are provided only by way of examples of types commonly found on the Web. Note that scroll bars and arrows for drop down lists are used with appropriate types to conserve display area in a GUI, while allowing for viewing longer text or lists of items not otherwise viewable.

Radio type (FIG. 4A) feedback uses bullets or buttons in a list. One click is all that is required by a surfer to provide feedback

List type (FIG. 4B) feedback uses up and down arrows to scroll a list of possible answers. Clicking one of the answers highlights it as the choice of the surfer.

Text line type (FIG. 4C) feedback provides a surfer with a default answer which may be edited. Clicking Enter activates the response.

Select type (FIG. 4D) feedback provides a surfer with a scrollable list of default answers which are displayed in a drop-down list.

Text area type (FIG. 4E) feedback provides a comma-delimited series of default answers which a surfer may edit to indicate a choice. Alternatively, a surfer can edit the default answers or type in a new answer.

FIG. 5 shows a flowchart of the general workflow of the Feedback engine in accordance with a preferred embodiment of the present invention;

The flowchart outlines the method enabling Feedback copywriters to setup and edit displays of questions/answers using the Feedback engine. More particularly, a Feedback copywriter loads a question at Load block 76 which activates a surfer's browser whenever the surfer accesses a page on which the Feedback engine call code is present.

A Website manager is generally responsible for entering a piece of static code in the Web page, in a specified location to enable this function. Code inclusion is done only once by a Site manager (write access to the Web page is required). This is the only programming that needs to be done in order to use the Feedback engine in accordance with the principles of the invention.

A single feedback question with answers pre-formatted by type (see FIG. 4 for examples) from the virtual page basket (all relevant questions present in feedback databases) are randomly displayed at block Display question 78. These are provided from Questions and Answers databases 20 and 22, respectively (as shown in FIG. 1) of the Feedback engine. In a preferred embodiment of the system of the invention, the GUI display screen appears on-line in a fixed position inside the page, or as “levitating” over the surfer's screen, or may be imbedded in the form of a new window.

A user of the feedback system has the option to interact with Feedback Tutorial at block 80, which opens a link over the Web to a Feedback Services Provider, in accordance with a preferred embodiment of the invention. The code to call the Feedback engine tutorial is provided at Feedback Tutorial block 80, which links the displayed page to the Feedback engine. A specific Web page that includes such code will result in the inclusion of a question, dynamically chosen by the Feedback engine using the actual HTML display protocol implemented in the Internet.

In a preferred embodiment of the invention, before proceeding with the workflow after displaying a question at block Display Question 78, an authorization window at block Authorization 82 is automatically displayed to a user before loading Questions Editor 84. This action occurs whenever a user chooses to click an editor link in the feedback question database. A user is required to submit a username and an authorized password, since access to Questions Editor 84 is intended primarily for a Feedback copywriter. Users database 26 of the Feedback engine matches and authenticates the password supplied, against a stored list of usernames and passwords assigned to registered users. (The username is the email address of the user.) If registered, a Feedback copywriter then is enabled to continue the workflow process. This ensures privacy and only authorized access to the feedback editing function. Authorization also enables the Feedback engine to present all relevant data to the specific user at block Question editor 84. The Feedback copywriter can then navigate through the data, including other pages in the same site and other pages from different sites, for which the Feedback copywriter has registered with the same username.

It should be noted that Question editor 84 also loads, and presents in the same screen, specific question details, and enables editing by minimal clicks of relevant question parameters, as explained heretofore in connection with FIG. 3.

FIG. 5 also shows a convenient Help system at block 52 available for working with the Feedback engine in accordance with the principles thereof, a block, View answers 54, and a block, Test 74 whose functions are as described heretofore in conjunction with the feedback engine shown in FIG. 3.

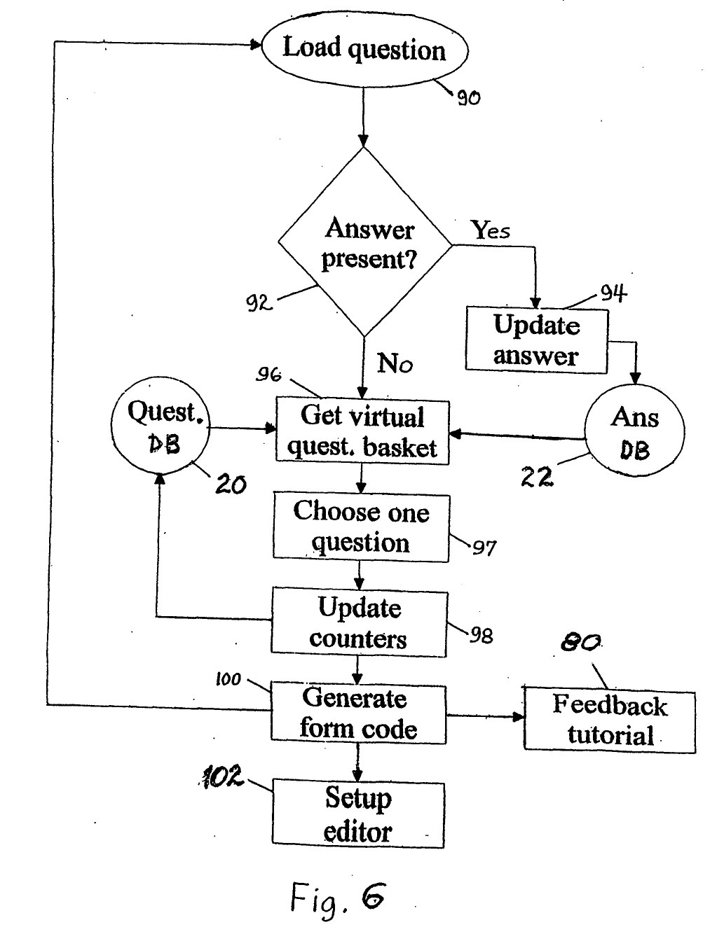

FIG. 6 shows a flowchart of the workflow for loading feedback questions/answers in accordance with a preferred embodiment of a method of the present invention.

A user loads a Question at block 90 which may or may not have Feedback answers present. If the Feedback engine determines, at decision block 92, that there are answers present (‘YES’), then Answer database 12 of the Feedback engine is updated at Update answer block 94.

If the answer is not present (‘NO’), the Feedback engine proceeds to load another question from a virtual question basket at block, Get Virtual Question Basket 96. The next question is randomly selected from a virtual basket of pages provided by the Feedback engine from the Questions and Answers databases, 20 and 22 respectively. After a user selects a question at block Choose one question 97, the Feedback engine automatically updates the data at Update counters 98 for Question database 20 and creates dynamic form code at block Generate form code 100. The form code generated is returned to the Web page at entry block 90 for display. The workflow cycle is then repeated with another question.

Optionally, a Feedback copywriter can access Setup Editor at step 102 for maintaining the Feedback engine databases and performing other management functions as needed. There is also an option, in accordance with a preferred embodiment of the invention, for any surfer, and Feedback copywriters in particular, to access the home page of the Feedback Services Provider at block Feedback Tutorial 80.

In accordance with a preferred embodiment of the invention, the question-editing results and the already collected answers and statistics may appear on the same page, reducing to zero the clicks needed to see this data.

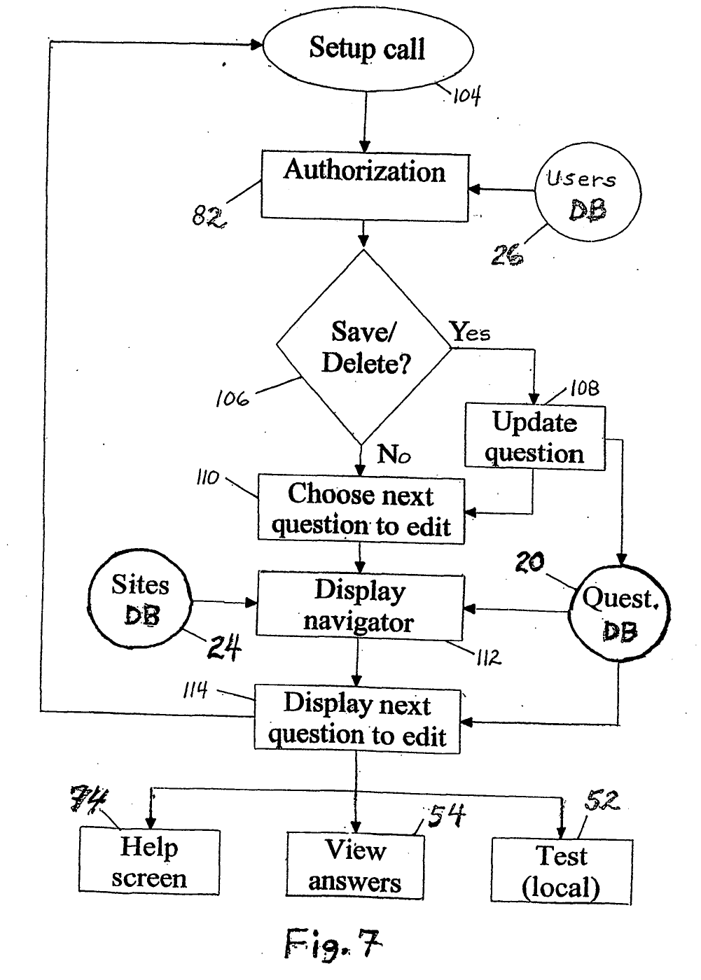

FIG. 7 shows a flowchart for the method of set up and editing of feedback questions and answers in accordance with a preferred embodiment of the present invention.

At entry step Setup Call 104, a user provides his username and password to the system. If the user has already gained access to the system, the user's Database 26 allows immediate re-entry.

At decision node 106, a particular feedback question may be saved or deleted, as appropriate for a user. If the answer is ‘yes’, then the Feedback engine updates the system at block Update question 108 which saves or deletes the data from Question database 20 and displaying a selection of other questions in block Choose next question to edit 110. If the answer at decision node 106 is ‘no’, the process continues directly to block 110 to select the next question.

The feedback GUI illustrated by way of example in FIG. 3, provides for selection of questions using the down arrow 42. It is the upper portion of this GUI display which serves as a virtual navigator and which is enabled at Display Navigator block 112 and supported by databases Sites 24 and Questions 20. At block 114, the system displays the next question to edit, drawn from a link with a virtual basket of questions stored in Question DB 20. The system then returns a user to Setup call 104 to enable another editing operation.

The block Test (local) 52 is intended to display the edited question locally and like View answers block 54, and block Help 74, are intended for particular use by a Site manager, and function as described heretofore in relation to the general workflow in FIG. 5.

Having described the present invention with regard to certain specific embodiments thereof, it is to be understood that the description is not meant as a limitation, since further modifications will now suggest themselves to those skilled in the art and it is intended to cover such modifications as fall within the scope of the appended claims.

1. A dynamic, Web-based, feedback polling system comprising:
a virtual Feedback engine comprising a normalized database for storing and processing at least one feedback object selected from a plurality of feedback objects, said at least one feedback object comprising at least one feedback question and at least one associated default answer, said engine being in communication over the Internet with at least one surfer, and being activated by a fixed, single line of embedded code contained in at least one Web page for controlling the display of said feedback object in said at least one Web page downloaded by said at least one surfer,
at least one database in communication with said engine for storing at a minimum, a plurality of feedback questions, associated default answers, feedback site addresses and information on users of said system;
a graphic user interface (GUI) for operating said system and for enabling setup and editing of said stored feedback questions and said associated default answers,
said system providing access to said at least one feedback object by a surfer for responding to said at least one feedback question using a minimal number of clicks, and providing access to said Feedback engine by authorized users, said authorized users performing, via said GUI, setup and editing operations of parameters associated with said feedback object displayed to said at least one surfer,
said system also providing at least one summary report and analysis of a plurality of said surfer responses.

2. The system of claim 1, wherein said Feedback engine comprises a database server for storing and dynamically generating all display protocol codes, and displaying, maintaining, monitoring, recording information flow and data, and making all calculations needed for maintaining a feedback collecting interface connectable to said at least one Web page.

3. The system of claim 1, wherein, said line of code is a fixed call inserted into said any Web page.

4. The system of claim 1, wherein said at least one feedback question from mid plurality of feedback questions stored in said at least one database is delayed to said surfer, prompting said surfer to provide a response on-line using a minimal number of clicks to participate in feedback activity.

5. The system of claim 4, wherein said response from said surfer is collected by said Feedback engine in said at least one database for storing and processing.

6. The system of claim 4, wherein said minimal number of clicks is dependent on a parameter applied to said default answers provided for use in response to said at least one feedback question generated by said Feedback engine, said parameter determining the format required for providing relevant, Web-based, feedback answers.

7. The system of claim 1, wherein said GUI provides optimal utilization of display resources.

8. The system of claim 7, wherein said optimal utilization of said GUI is provided by said Feedback engine generating said GUI, with minimal set up fields and requiring only minimal clicks to fill said fields.

9. A feedback operating method comprising:
loading at least one feedback object for display to a surfer in a GUI;
positioning said object in at least one of a fixed position for said object and a levitating state above a Web page called by said surfer,
pausing for a specified time period to await a response from said surfer,
reloading a different feedback object after expiration of said specified time period for said response from said surfer,
transmitting gathered responses; and
reloading at least one new feedback object for display to said surfer on said GUI.

10. The method of claim 9, wherein said levitating state for said feedback object displayed on said Web page eliminates the need for changing said Web page and enables fine tuning of attention-calling behaviors comprising;
entrance timing;
movement speed and acceleration;
pauses; and
exit from the viewing window.

11. The method of claim 9, wherein said feedback responses comprise a one-character delimited list of said associated default answers in just one field is enabled with a minimal number of clicks, while the overall number of available ones of said associated default answers is only limited by the length of said one field.

12. A feedback set-up and question-editing method comprising:
calling a Feedback engine inside a Web page source code;
receiving user authorization for performing at least one editing operation;
selecting a feedback question; and
performing said at least one editing operation, including displaying, saving, deleting, and modifying said feedback question with minimal clicks and utilizing minimal set-up and editing fields to fill;
providing at least one associated default answer to said feedback question; and
viewing said at least one associated default answer to said feedback question

13. The set-up and editing method of claim 12, further comprising:
receiving at least one further feedback question to edit;
editing said at least one further feedback question;
calling up a Help screen for on-line guidance in performing said at least one editing operation; and
testing said at least one feedback question.

14. The set-up and editing method of claim 12, wherein said user authorization is provided to users upon entry into a GUI of a valid username and password.

15. The set-up and editing method of claim 12, wherein said username is the email address of said user.

16. The set-up and editing method of claim 13, wherein said testing simulates the look and feel of presenting said feedback question on-line on the Web.

17. The set-up and editing method of claim 13, wherein said editing method, once performed, enables maintaining the feedback collecting activity, and reduces said activity to the minimal number of clicks required to edit syntax and said parameters for performing feedback services configuration and feedback data processing.

18. The set-up and editing method of claim 13, wherein said editing enables insertion and editing of feedback questions and related answers just by typing the question in the question field, and typing in appropriate answers in at least one of a comma-delimited series of displayed answers and a default answer string, said answers formatted in accordance with the Type of said feedback question, and entered with a minimal number of clicks in a minimal number of answer fields to fill.
